(19) United States
(12) Patent Application Publication
(10) Pub. No.: US 2010/0316144 A1
(43) Pub. Date: Dec. 16, 2010

(54) EFFICIENT FRAMING SCHEMES FOR SUPPORTING VCM/ACM IN DIGITAL SATELLITE TRANSMISSION SYSTEMS

(75) Inventors: Fengwen Sun, Germantown, MD (US); Ming Yang, Beijing (CN); Yimin Jiang, Vienna, VA (US); Guofang Sheng, Beijing (CN); Zhenliang Shi, Germantown, MD (US); Yingjiu Xu, Rockville, MD (US)

Correspondence Address: DICKINSON WRIGHT PLLC, 1875 Eye Street, NW, Suite 1200, WASHINGTON, DC, 20006, US

(73) Assignee: AVAILINK, INC., Germantown, MD (US)

(21) Appl. No.: 12/771,723

(22) Filed: Apr. 30, 2010

Related U.S. Application Data
(63) Continuation of application No. 11/813,204.

(51) Int. Cl. H04L 27/20; H04L 27/00

(52) U.S. Cl. 375/259; 375/295; 375/308

(57) ABSTRACT

A digital communication system and method using a digital signal having a plurality of frames to transmit data, including a first frame and a second frame, wherein each of the plurality of frames has a frame structure; and wherein the first frame has, a plurality of codewords comprising user data, and a Next Frame Composition Table to set the structure for the second frame, and wherein the second frame has at least one codeword.

### RELATED APPLICATIONS

This application is a continuation of U.S. patent application Ser. No. 11/813,204, filed Jun. 29, 2007, which is the U.S. National Stage of International Application No. PCT/CN2006/002425, filed Sep. 18, 2006 and claims the benefit thereof. This application relates to application Ser. No. 11/813,205, filed Jun. 29, 2007.

### FIELD OF THE INVENTION

The present invention relates to digital satellite communication and in particular a frame design for transmitted signals to provide better support for variable/adaptive coding and modulation schemes.

### BACKGROUND OF THE INVENTION

The objective of modern digital communication systems is to transmit audio/video signals and data bits from a source to a destination with high power, bandwidth efficiency, and low cost hardware implementation for commercial competitiveness. To achieve this objective, a primary problem in receiver design relates to symbol timing synchronization and frame synchronization. Symbol timing synchronization includes processes and methods for synchronizing received data streams with transmitted data streams at the symbol level. Frame synchronization is critical for digital communications where digital data is sent frame by frame, and each frame contains a number of data bits. Depending on the system, frame sizes can vary. Each frame usually contains two parts: a header and a payload. Headers typically include important information for frame synchronization as well as a modulation type and a coding rate for the payload. Payloads typically contain the actual data protected by the channel coding. Frame formatting design is very critical for overall system performance and can directly impact product and operating costs. A preferred frame format may result in high performance receivers that achieve fast frame acquisition and reliable tracking (time and frequency lock) to improve system performance in terms of either bit error rate and/or packet error rate with minimal overhead and a low cost implementation.

In the current digital satellite communication standards such as DVB-S and DVB-S2, each frame has a fixed number of codewords. Because both VCM and ACM support different modulation schemes and forward error correction codes (FEC's), the number of coded symbols and/or the length of payloads vary from frame to frame. For example, in a system having 1200 information bits, if the bits are encoded by a rate ½ code, 2400 coded bits will result. When using a QPSK modulator, this will be equivalent to 1200 QPSK symbols because each QPSK symbol has two bits. In 8-PSK modulation, this will be equivalent to 800 8-PSK symbols since each symbol has three bits. In addition, DVB-S2 has two LDPC codes for each code rate, a long one of 64800 coded bits and a short one of 16200 coded bits. Consequently, each frame will have a different length/number of symbols depending on which modulation schemes and FEC codes are used. This difference in frame size complicates receiver design, which is usually further complicated by various channel distortions such as group delays, background noise, adjacent channels and/or other interferences.

### BRIEF SUMMARY OF THE INVENTION

One of the benefits of the invention is to eliminate the above mentioned problems by fixing frame sizes regardless of the modulation schemes and/or coding rates used. According to an embodiment of the invention, each frame begins with a header that contains a synchronization waveform called a unique word (UW), followed by an auxiliary control code (ACC), which specifies the modulation scheme and the coding rate of the first codeword in the current frame. In addition to coded data symbols, the first codeword may also contain a “next frame composition table” (NFCT) to specify modulation schemes and coding rates for some or all of the codewords in the next frame and/or the following frames. The total number of symbols in a frame or the frame size is fixed. In an embodiment of the invention, the receiver knows that the UW position is fixed in the ACM/VCM mode. Hence, synchronization control can be simplified.

Another benefit is that data streams of different modulation and/or code rates can be handled simultaneously in the ACM mode. In current systems such as the DVB-S2 standard, data of different modulation types are kept in different queues. For any particular queue, each queue must accumulate enough data to fill up one frame before it starts to transmit. Hence, this queuing delay is of a random nature and fluctuates depending on the instantaneous arrival rate of the data. According to various embodiments of the invention, data of different modulation types and code rates can be sent in a single frame. Although sufficient data is generally accumulated to fill up one codeword, since the length of the codeword is much shorter than that of the DVB-S2 long codes, the average queuing delay and the extent of its variation will be much smaller.

Another benefit is that in various embodiments of the invention, the unique word position and the frame size of the VCM and the ACM modes are the same as those of the CCM mode, thus the VCM mode and the ACM mode are compatible with the CCM mode. Because the CCM mode are widely used in broadcasting services, this compatibility allows the VCM and the ACM modes to be easily integrated into existing systems without incurring huge equipment cost.

An additional benefit is that according to various embodiments of the invention, the VCM mode allows for flexibility in satisfying various link budget requirements without incurring additional cost in receiver design. Generally different users have different link budget requirements. The VCM mode is designed to allow different users to use different modulation types and code rates depending on their individual link budget requirement. Thus the VCM mode provides more flexibility than the CCM mode, which by contrast can not change either the modulation or the code rate from one user to another. Although the link budget requirements change with users, the link budget requirement for each user is usually fixed, hence the modulation and the code rate is usually fixed. Consequently the receiver design for the VCM mode is no more complicated than that for the CCM mode.

According to an embodiment of the invention, the number of pilot symbols can change the frame size. In this embodiment, pilot symbols may be inserted uniformly during a frame. Depending on whether pilot symbols are used and how many pilot symbols are used in each pilot section, the frame size will vary accordingly. According to another embodiment of the invention using the VCM and the ACM modes, the methods of using pilot symbols are usually fixed in real transmissions and will not change from one frame to another.

According to an embodiment of the invention, each frame has multiple LDPC codewords. The ACC only specifies the modulation and the code rate of the first codeword in the ACM mode, the remainder of the codewords are specified by the NFCT in the first codeword of the previous frame.

According to a further embodiment of the invention, the use of NFCTs may result in smaller transmission overhead in ACM transmissions. In DVB-S2, the modulation and/or the code rate are specified in a special part of the header called MODCOD, which encodes modulation and coding rate information using Reed-Muller code. Each MODCOD has 64 QPSK symbols that jointly specify modulation and code rate for one LDPC codeword. In the ACM mode in DVB_S2, the transmission overhead due to MODCOD can be very high, especially for high-order modulation schemes like 16APSK and 32APSK and DVB-S2 short codes. According to another embodiment of the invention, the NFCT is encoded using LDPC codes whose rates are much higher than the Reed-Muller code used by the DVB-S2 standard. For example, various embodiments of the invention may use an LDPC encoder of rate of ¼, the minimum code rate supported in the DVB-S2 standard, while the rate for the Reed-Muller code in DVB-S2 is 1/16. Furthermore, unlike DVB-S2 MODCOD, the first codeword can be of any modulation schemes, such as, but not limited to, QPSK to 32APSK, which can further reduce the transmission overhead.

According to an embodiment of the invention, that the NFCT has a delay of one frame is because the receiver does not typically know the content of the NFCT until the first codeword has been decoded by an LDPC decoder. Generally this one-frame delay is acceptable for most of applications. For example, in reality channel conditions due to rain and/or other environmental conditions usually change slowly, hence the ACM only needs to change the modulation and coding rate occasionally. Furthermore, this one-frame delay is negligible compared to the satellite transmission delay, which is usually as high as a few hundred mille-seconds due to the height of the geostationary orbit. For instance, at a symbol rate of 30 Msps and a frame size of 30,000 symbols, a one-frame delay is only about 1 ms.

According to an embodiment of the invention, for low-symbol rate, delay sensitive applications, the modulation and/or coding rate of the first codeword in a frame may be overwritten by the ACC of the same frame in the ACM mode such that the one-frame delay may be eliminated for the first codeword. Accordingly, the first codeword can be used to carry delay-sensitive data while the other codewords can be used for non-delay-sensitive data.

According to an embodiment of the invention, an efficient framing scheme is used to support variable/adaptive coding and modulation (VCM/ACM) schemes in a digital satellite transmission system. In the VCM and the ACM modes, modulation and coding rates change from frame to frame. The ACM mode uses a return channel to adjust the modulation and/or coding rate based on feedback information. According to an embodiment of the invention, improved support is provided for the VCM mode because the modulation/coding format does not change within a frame.

According to an embodiment of the invention, when using the ACM mode, a NFCT is used in the first codeword of a frame, which specifies the modulation and coding of all the codewords in the next frame. Accordingly, different codewords can use different modulation types and coding rates while the total number of the symbols from all the codewords is fixed.

Various embodiments of the invention may include, a digital communication system using digital transmissions, the digital transmissions comprising: a plurality of frames to transmit data, wherein each of the plurality of frames has a frame structure; wherein each frame comprises, a frame header, and a plurality of codewords, one of which contains a Next Frame Composition Table to set the structure for the next frame.

According to an embodiment of the invention, the plurality of codewords in each frame comprises a first codeword, and the Next Frame Composition Table is in the first codeword.

According to an embodiment of the invention, the digital communication system uses the ACM mode.

According to an embodiment of the invention, the digital communication system uses the VCM mode.

According to an embodiment of the invention, the Next Frame Composition Table is to set the structure for the next frame.

According to an embodiment of the invention, the Next Frame Composition Table defines the number of codewords per frame.

According to an embodiment of the invention, each of the plurality of frames comprises at least one codeword.

According to an embodiment of the invention, a receiver can make use of the Next Frame Composition Table to determine where the codewords start and stop.

According to an embodiment of the invention, the Next Frame Composition Table defines a structure of the codewords for the next frame.

According to an embodiment of the invention, the Next Frame Composition Table defines a padding structure for the next frame.

According to an embodiment of the invention, the plurality of codewords in each frame comprises a first codeword, and the Next Frame Composition Table is in a codeword other than the first codeword.

According to an embodiment of the invention, the system uses at least one of the following modulation schemes: QPSK, 8PSK, 16APSK or 32APSK.

According to an embodiment of the invention, the structure for the second frame comprises a modulation and/or a coding format.

According to an embodiment of the invention, the modulation and/or coding format of the first codeword in a frame can be overwritten by the auxiliary control code in the frame header.

According to an embodiment of the invention, codewords in at least one of the plurality of frames use different modulation.

According to an embodiment of the invention, codewords in at least one of the plurality of frames use different FEC code rates.

According to an embodiment of the invention, the Next Frame Composition Table reduces transmission overhead when the system uses the ACM mode

According to an embodiment of the invention, delay-sensitive data is located in a first codeword of one frame and non-delay-sensitive data is located in other codewords in the frame.

According to an embodiment of the invention, wherein data streams in different modulation and code rates can be transmitted simultaneously in the ACM mode.

According to an embodiment of the invention, wherein the unique word position and the frame length of the VCM mode and of the ACM mode are the same as those of the CCM mode, which is commonly used in broadcasting services.

According to an embodiment of the invention, wherein the VCM mode and the ACM mode are compatible with the CCM mode that is used in broadcasting services.

According to an embodiment of the invention, wherein for the VCM mode the modulation and the code rate are fixed for all the codewords in one frame.

According to an embodiment of the invention, wherein the VCM mode can accommodate different users with different link budget requirements.

Various embodiments of the invention include, a digital communication system, comprising: a transmitter to transmit a digital signal; and a receiver to receive a digital signal; wherein the digital signal comprises, a plurality of frames to transmit data, wherein each of the plurality of frames has a frame structure; and wherein each frame comprises, a frame header, and a plurality of codewords, one of which contains a Next Frame Composition Table to set the structure for the next frame.

### BRIEF DESCRIPTION OF THE DRAWINGS

FIG. 1 depicts an exemplary detailed frame format of a transmitted frame, according to an embodiment of the invention.

FIG. 2 depicts an exemplary frame having a payload data structure using multiple LDPC codewords, according to an embodiment of the invention.

FIG. 3 depicts an exemplary format of a first LPDC codeword of a frame, according to an embodiment of the invention.

FIG. 4 depicts an exemplary format for additional LDPC codewords, according to an embodiment of the invention.

FIG. 5 depicts an exemplary NFCT bit and byte structure, according to an embodiment of the invention.

### DETAILED DESCRIPTION OF THE INVENTION

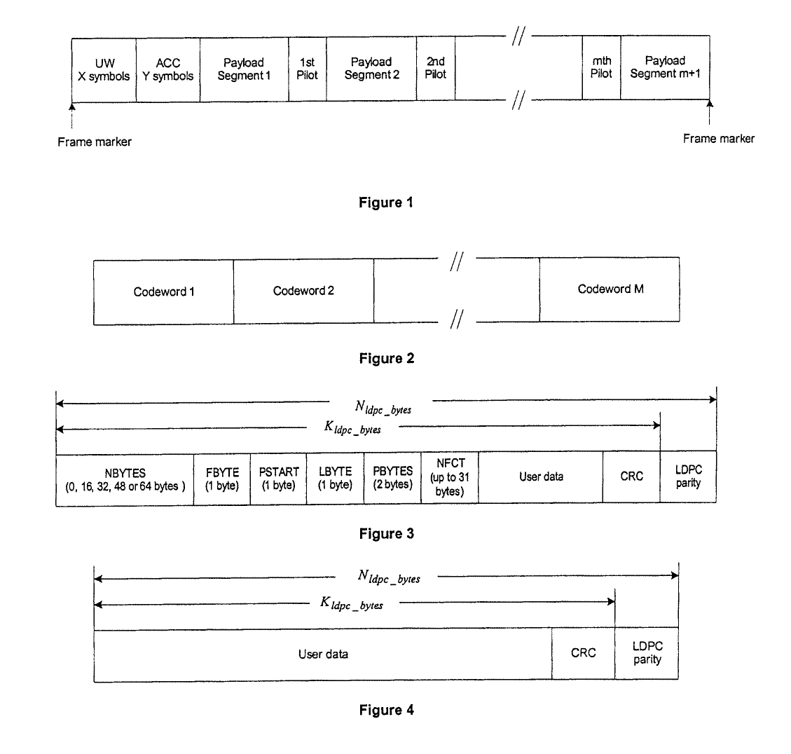

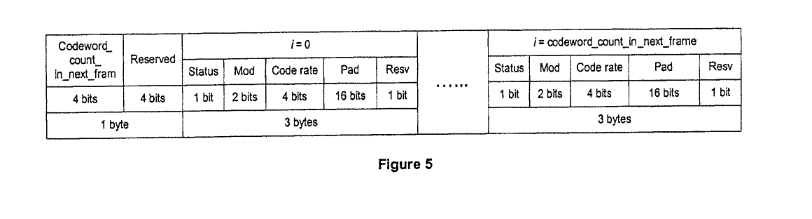

According to an embodiment of the invention, FIG. 1 depicts an exemplary detailed frame format of a transmitted frame. The frame format starts with an X-symbol UW pattern, followed by a Y-symbol ACC, and m+1 segments of encoded data (or payload data) separated by m evenly distributed pilot sections. The UW is designed to yield an improved correlation property for faster acquisition. An exemplary UW may contain detailed information on frame structures.

According to a further embodiment of the invention, the number of payload segments (m+1) in each frame is determined by the frame length in symbols and the distance between two consecutive segments, which may be designed to provide reliable synchronization with minimum overhead. For systems having severe channel conditions and using high dimensional modulations, more pilots are used. Furthermore, the size of each pilot segment may also be adjustable. According to an embodiment of the invention, in some cases frames having no pilot symbols may be used to achieve minimal overhead. In this case, modulation dimensions are usually low and the channel is usually in fair conditions. According to various embodiments of the invention, the number of pilot symbols used may be determined by the worst channel conditions and/or the most demanding modulation and/or coding rate; they may also be designed so as to not change from one frame to another.

As illustrated in FIG. 2, in various embodiments of the invention, an integer number of LDPC codewords is assigned in each frame as the payload data. This design leads to simple decoder control logic where the decoder does not need to decode payloads across a frame boundary.

Furthermore, the codeword itself may have a constant length in bits to simplify the decoding implementation. Additionally, each codeword may have a different modulation type and/or code rate to support the ACM mode. The number of codewords in a frame may depend on the modulation dimensions. Higher modulation dimensions may lead to more codewords in a frame.

Table 1 provides exemplary distributions of frame resources. In some embodiments user data may not be continuous; accordingly, a format other than the format defined in the table may be used. Consequently, there may be some unused symbols towards the end of a frame which may be defined as dummy symbols and may be modulated by an all-zero or an all-one bit pattern.

TABLE 1
Assignment of CodeWords to Each Modulation Dimension

| | | Combination index | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Modulation | 2 | 4 | | | | 3 | 2 | 2 | 2 | 1 | 1 | 1 | | | |
| dimension | 3 | | 6 | | | | 3 | | | | 3 | | 3 | 3 | |
| | 4 | | | 8 | | 2 | | 4 | | 6 | 2 | 2 | 4 | | 4 |
| | 5 | | | | 10 | | | | 5 | | | 5 | | 5 | 5 |

According to various embodiments of the invention, codewords may be made up of information bits and FEC parity bytes having a CRC error checking field and/or an LDPC error correction field. But not all the codewords need to be designed to be the same. According to an embodiment of the invention, within each frame, the first codeword (as shown in FIG. 3) is different from other codewords (shown in FIG. 4) in that it contains header information for another frame. The first three fields, NBYTES, FBYTE, and PSTART, may be used by all modes of operation. The other fields depicted, LBYTE, PBYTES, and NFCT, are typically not used in transport streams. According to an embodiment of the invention, in a typical stream, the NFCT may be used in only the ACM mode.

According to various embodiments of the invention, the NFCT is designed for ACM applications where each codeword may be independent of others in a frame in terms of modulation type and/or code rate. The NFCT defines the composition of the frame following the current frame. An exemplary NFCT may follow the PBYTES and may have the syntax shown in Table 2. Corresponding exemplary bit and byte positions are also illustrated in Table 2.

TABLE 2
NFCT definition.

| | No. of bits | |
|---|---|---|
| Syntax | reserved | information |
| Next_Frame_Composition_Table( ){ | | |
| Codeword_count_in_next_frame | | 4 |
| | 4 | |
| For(i=0;i<= | | |
| codeword_count_in_next_frame;i++){ | | |
| Status | | 1 |
| Modulation | | 2 |
| Code_rate | | 4 |
| Padding_in_bytes | | 16 |
| | 1 | |
| } | | |
| } | | |

The terms used in Table 2 may have the following meanings:

Codeword_count_in_next_frame: this is a 4-bit field indicating one less than the number of LDPC codewords in next frame. The codeword index i starts from 0 to Codeword_count_in_next_frame≧0. Accordingly, in this embodiment, at least one codeword in a frame is always transmitted, i.e., the first codeword of each frame is guaranteed for transmission.

Status: 1 bit indicating the codeword status. 1=valid payload, 0=no payload data or empty codeword (zeros padded). When this bit is 0, it may not be necessary to demodulate and/or decode the codeword.

Modulation: 2 bits to indicate the modulation scheme.

Code_rate: 4 bits to indicate the code rate.

Padding_in_bytes: zero padding in that particular codeword in bytes. The number of bytes to be padded with zeros is given by:

$${N}_{zero\_pad} = {\sum }_{i = 0}^{10} {b}_{l} \cdot {2}^{i} ,$$

where b₁₅ to b₁₁ are reserved and b₀ represents the LSB of the 16 bits.

It is understood that some of the fields may have different bit widths for different applications.

It is also understood that when the NFCT is not used, such as in the CCM or the VCM mode, the codewords of a frame must be of the same modulation and FEC code rate in those two modes, which is specified by the ACC.

The foregoing description of the preferred embodiment of the invention has been presented for the purposes of illustration and description; it is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A digital communication system using digital transmissions, the digital transmissions comprising:
a plurality of frames to transmit data, including a first frame and a second frame, wherein each of the plurality of frames has a frame structure;
wherein the first frame comprises,
a plurality of codewords comprising user data, and
a Next Frame Composition Table to set the structure for the second frame, and wherein the second frame comprises at least one codeword.

2. The digital communication system of claim 1, wherein the first frame further comprises a header, and the Next Frame Composition Table is in the header.

3. The digital communication system of claim 1, wherein the plurality of codewords in the first frame comprises a first codeword, and the Next Frame Composition Table is in the first codeword.

4. The digital communication system of claim 1, wherein the digital communication system uses an ACM mode.

5. The digital communication system of claim 1, wherein the digital communication system uses a VCM mode.

6. The digital communication system of claim 1, wherein the Next Frame Composition Table is to set the structure for every frame except the first frame.

7. The digital communication system of claim 1, wherein the Next Frame Composition Table defines the number of codewords per frame.

8. The digital communication system of claim 1, wherein each of the plurality of frames comprises at least one codeword.

9. The digital communication system of claim 1, wherein the Next Frame Composition Table is used to determine where the codewords start and stop.

10. The digital communication system of claim 1, wherein the Next Frame Composition Table defines a structure of the codewords.

11. The digital communication system of claim 1, wherein the Next Frame Composition Table defines a padding structure for at least one frame.

12. The digital communication system of claim 1, wherein the plurality of codewords in the first frame comprises a first codeword, and the Next Frame Composition Table is in a codeword other than the first codeword.

13. The digital communication system of claim 1, wherein the system uses at least one of the following modulation types: QPSK, 8PSK, 16APSK or 32APSK.

14. The digital communication system of claim 1, wherein the structure for the second frame comprises a modulation and/or a coding format.

15. The digital communication system of claim 14, wherein the modulation and/or coding format of the first codeword in a frame is overwritten by an auxiliary control code.

16. The digital communication system of claim 1, wherein codewords in at least one of the plurality of frames use different modulation.

17. The digital communication system of claim 1, wherein codewords in at least one of the plurality of frames use different FEC code rates.

18. The digital communication system of claim 1, wherein the Next Frame Composition Table reduces transmission overhead when the system uses the ACM mode

19. The digital communication system of claim 1, wherein delay-sensitive data is located in a first codeword of the first frame and non-delay-sensitive data is located in at least one other of the plurality of codewords in the first frame.

20. The digital communication system of claim 1, wherein data streams having different modulation and code rates are to be transmitted simultaneously in the ACM mode.

21. The digital communication system of claim 1, wherein a unique word position and a frame length in a VCM mode and an ACM mode are the same as those of a CCM mode.

22. The digital communication system of claim 20, wherein the VCM mode and the ACM mode are compatible with the CCM mode.

23. The digital communication system of claim 1, wherein for a VCM mode a modulation and a code rate are fixed for all the codewords in each frame.

24. The digital communication system of claim 1, wherein a VCM mode can accommodate different users with different link budget requirements.

25. A method of digital communication, comprising:
transmitting a digital signal; and
receiving a digital signal;
wherein the digital signal comprises,
a plurality of frames to transmit data, including a first frame and a second frame, wherein each of the plurality of frames has a frame structure; and
wherein the first frame comprises,
a plurality of codewords comprising user data, and
a Next Frame Composition Table to set the structure for the second frame, and
wherein the second frame comprises at least one codeword.

26. A digital communication system, comprising:
a transmitter to transmit a digital signal; and
a receiver to receive a digital signal;
wherein the digital signal comprises,
a plurality of frames to transmit data, including a first frame and a second frame, wherein each of the plurality of frames has a frame structure; and
wherein the first frame comprises,
a plurality of codewords comprising user data, and
a Next Frame Composition Table to set the structure for the second frame, and
wherein the second frame comprises at least one codeword.

27. A digital communication system using digital transmissions, the digital transmissions comprising:
a plurality of frames to transmit data, wherein each of the plurality of frames has a frame structure comprising,
a frame header, and
a plurality of codewords, one of which comprises a Next Frame Composition Table to set the frame structure for the next frame.

28. A method of digital communication, comprising:
transmitting a digital signal; and
receiving a digital signal;
wherein the digital signal comprises,
a plurality of frames to transmit data, wherein each of the plurality of frames has a frame structure; and
wherein each of the plurality of frames comprises,
a frame header, and
a plurality of codewords comprising user data, wherein at least one of the codewords comprises a Next Frame Composition Table to set the structure for the next frame.

29. A digital communication system, comprising:
a transmitter to transmit a digital signal; and
a receiver to receive a digital signal;
wherein the digital signal comprises,
a plurality of frames to transmit data, wherein each of the plurality of frames has a frame structure; and
wherein each of the plurality of frames comprises,
a frame header, and
a plurality of codewords comprising user data, wherein at least one of the a Next Frame Composition Table to set the structure for the next frame.
